(19) United States
(12) Patent Application Publication
(10) Pub. No.: US 2010/0276075 A1
(43) Pub. Date: Nov. 4, 2010

(54) BONDING AND LAYERING OF SHEETS OF RAW MATERIAL

(76) Inventors: Antonio Manzoni, Bagnatica (IT); Karl-August Kumpf, Torre De Roveri (IT); Gerhard Egerer, Trabitz (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/376,736

(22) PCT Filed: Aug. 8, 2007
(86) PCT No.: PCT/EP07/58249

§ 371 Date: Jul. 22, 2010

(30) Foreign Application Priority Data
Aug. 8, 2006 (EP) 06118602.9

(51) Int. Cl. B29C 43/18

(52) U.S. Cl. 156/245

(57) ABSTRACT

The invention relates to a method for producing an inner covering part for motor vehicles, the method comprising the steps: collecting raw material layers, inserting said raw material layers together with a glue between said raw material layers into a molding tool (11) such that said raw material layers make up a stack (1) in said molding tool (11) and at least a part of the surface of said stack (1) is adjacent to a cavity (6) of the closed molding tool (11), introducing a molding material into the cavity (6). In said molding tool (11), raw material layers of said stack (1), not yet connected before their introduction, are glued together under heat supply or pressure or both.

### TECHNICAL FIELD

The present invention relates to a method for producing an inner covering part for motor vehicles.

### PRIOR ART

Covering parts for motor vehicles are widely spread. In particular, they are used for the inner equipment of a motor vehicle. A typical inner covering part is for example a decoration element for an instrument panel in a car, displaying a wood grain. The term “motor vehicle” shall mean hereunder all motorized land, water, or air vehicles having an inner compartment for transporting persons, which compartment typically comprises such covering parts.

Frequently, such inner covering parts comprise a coated blank part. This blank part can comprise several layers that are usually connected to each other by a glue in a pressing tool under pressure and heat supply. The several layers of the blank part provide the mechanical properties desired and frequently have an influence on the aesthetic appearance of the completed inner covering part.

The completed blank part can be coated with a surface layer by means of an injection molding tool. This is called “front molding” (Überspritzen) if that side of the blank part is coated by an injection molding tool that is visible on the completed and mounted inner covering part; in case of the other side, the non-visible side, the term “back molding” (Hinterspritzen) is used, correspondingly. Inner covering parts may be coated on the back side in this sense in order to achieve a better stability or in order to form mounting elements; they may be coated on the front side in order to produce a certain surface preparation of the visible side of the inner covering part in the mounted state.

A typical injection molding tool is constructed such that it comprises or embraces the blank part in its closed condition and that the part to be coated of the surface of the blank part is adjacent to a cavity of the closed injection molding tool. This cavity is filled by the injection molding material, then; subsequently (after a hardening time if applicable) the injection molding tool can be opened and the blank part coated can be taken out.

EP 1 676 688 A1 shows a method for producing an inner covering part for motor vehicles. A thermoplastic carrier layer is pre-heated outside of the injection molding tool and inserted into the tool together with a decoration layer and pressed therewith, wherein the residual heat of the carrier layer enables a permanent connection of both parts, e.g. by means of an optionally present dry tacking foil. Thereafter, the carrier layer is back molded by a rib-like structure.

U.S. Pat. No. 6,887,413 B1 discloses a method for producing decoration and covering parts which supersedes a subsequent cutting-to-form of the completed decoration part. An increased tool temperature provides for an improved moldability and an improved hardening of an optionally present heat protection or glue layer. This document is the base of the preamble of claim 1.

JP 03 030921 A discloses a method for producing injection molding parts comprising wood veneer. The wood is pressed-to-form in an injection molding tool together with a protection plate, and the protection plate is back molded by a carrying structure.

WO 2004/073951 A1 shows a method for producing back molded decoration parts which are particularly well recyclable. This implies a lack of glue layers. The individual raw material layers are connected to each other by partial melting, wherein the heat necessary thereto is applied by the heated molding material. In order to avoid heat-caused damages of the surface visible later, the tool is cooled at the corresponding places.

### SUMMARY OF INVENTION

The technical object of the present invention is to provide an improved injection molding process for raw material layers with glue layers.

The invention relates to a method for producing an inner covering part for motor vehicles, the method comprising the steps: collecting raw material layers, inserting said raw material layers together with a glue between said raw material layers into a molding tool such that said raw material layers make up a stack in said molding tool and at least a part of the surface of said stack is adjacent to a cavity of the closed molding tool, introducing a molding material into the cavity, and gluing said raw material layers of said stack, being separated before said introduction of said molding material, in said molding tool under at least one of heat supply and pressure, characterized in that the temperature of said molding material introduced is between 190° C. and 330° C. and the temperature of said molding tool is between 90° C. and 160° C.

Heat is supplied to the stack by heated molded material. Preferably, the temperature of the molding material is between 240° C. and 280° C. More preferably, the molding material introduced has a temperature between 250° C. and 270° C.

The stack is also supplied with heat by the tool itself. A temperature of the molding tool between 110° C. and 140° C. is preferred. More preferably, the molding tool has a temperature between 120° C. and 130° C.

Preferred embodiments of the invention are defined in the dependent claims and will be explained here below. The disclosure relates both to a method according to the invention as well as to a molding tool for conducting said method.

The terms “molding tool” and “molding material” are generalizations of the terms “injection molding tool” and “injection molding material”. Injection molding is usually conducted under heat supply and pressure. The terms “molding tool” and “molding material” shall express that a coating by the molding material is not necessarily done under both, heat supply and pressure, but that implementations in which heat alone is supplied or a pressure alone is increased shall be encompassed as well.

The invention is based on the consideration that gluing a blank part can be conducted either under heat supply or under pressure, or alternatively under both, heat supply as well as pressure. The invention is based on the additional consideration that coating a blank part with a molding material in a molding tool can be conducted as well either under heat supply or under pressure, or alternatively under both, heat supply as well as pressure.

Heat and pressure are parameters in the production of a blank part which influence the glue process of the raw material layers by the glue present between the raw material layers. Frequently, the blank part is brought into a certain form by the application of pressure (compare preferred implementations below). When coating a blank part with a molding material in a molding tool, the entities pressure and temperature determine the flow of the molding material, predominantly.

There are numerous glues adequate for gluing raw material layers in a molding tool. Their bases are different materials having respectively different properties. Thus, for melting glue films (so-called “hot melts”, mostly on the basis of polyurethane) a sufficiently high temperature must be provided, only, whereas in case of contact glue films (mostly on the basis of acrylate or polyurethane) pressure is an important parameter, as an example. Numerous glues take advantage of both an increased temperature as well as an increased pressure, e.g. artificial-resin-bounded glue films on phenol, melamine, and/or urea basis.

A basic idea underlying the invention is to combine the gluing of the blank part from several raw material layers with the coating thereof by a molding material.

Hereto, the individual raw material layers are laid adjacent to each other in a primarily loose manner, wherein a glue is introduced between at least two raw material layers. The stack thus produced is adjacent to a cavity of the molding tool in the closed condition thereof by a part of its surface. The molding material is introduced into the cavity. In the closed state of the molding tool, the raw material layers of the stack, separated before, are glued together by either pressure or heat or alternatively under pressure and heat.

“Separate” means not only a loose arrangement of the raw material layer adjacent to each other but shall also encompass the case that the glue between the raw material layers already fixes the stack weakly or only at single places. The term “separate” comprises any coherence of the stack that is substantially less stable than the completely glued stack.

In case that heat is supplied to the stack, this can be done by heated molded material but also by a heating of the molding tool. If pressure shall be applied to the stack, this can be done during and by the introduction of the molding material. The pressure can also be applied independently from the introduction of the molding material. Thereto, the molding material can be introduced into the cavity first, supply and exit lines present can be closed, and the molding tool can be used to press the stack then, for example.

The method according to the invention can be used both for a coating of the front side and of the back side of the blank part. If the molding tool is an injection molding tool, this means that the invention can be used for front molding and for back molding and for the combination thereof. For a coating of the upper side, e.g. by front molding, transparent plastics are typically used, for example transparent thermoplasts as PMMA (polymethyl methacrylate), PC (polycarbonate), and SAN (styrol/acrylonitrile). If the stack is only coated on its front side, it is often provided with a carrier on the other side, for example a carrier of metal, e.g. aluminum, or of plastics. The carrier can enhance the stability of the inner covering part.

For coating the stack on the back side, such as by back molding, non-transparent plastics can be used because they are opposite to the visible side of the mounted inner covering part. Preferably, technical plastics having a high E-module are used to ensure a sufficiently stable inner covering part. This can be ABS (acryonitrile butadiene styrol copolymer) or ABS/PC plastics. If the stack shall be coated both on the front side and on the back side, the same material can be used for both sides. However, this is not necessarily the case.

The stack can comprise raw material layers of various materials, such as wood veneers, wherein also the use of multiple, even different, wood veneers in a stack can make sense, for example as a face veneer and as a substrate veneer or “cross band”. Therein, the face veneer substantially influences the subsequent appearance of the inner covering part whereas the substrate veneer influences the mechanical properties of the inner covering part. However, the stack can also comprise for example metal foils, wood fiber mats, and plastic foils, which can be provided more for stabilizing the inner covering part or more for its aesthetic design depending on the mechanical and aesthetical properties desired.

The invention supersedes and renders superfluous the separate gluing of a blank part before coating with a molding material. The gluing of the blank part and the coating can now be implemented together in one single tool.

Preferably, the gluing of the stack is performed both under pressure and heat supply, preferably by means of an injection tool known as such.

Commonly, completed blank parts have a certain form substantially corresponding to the completed inner covering part. Forming blank parts is based at least on the application of pressure. Thus, in the method according to the invention, the stack is preferably formed in the molding tool under pressure. In this embodiment of the invention, the raw material layer stack is thus both glued and formed in the molding tool.

Inner covering parts displaying a wood grain are particularly popular. Further, wood veneers are generally adequate as raw material layers for the method of the invention. This applies both to a use of a wood veneer as a face veneer and to the use as a substrate veneer arranged within the stack and participating in the determination of the stability of the inner covering part. Thus, wood veneers as raw material layers are preferred.

Dry tacking foils can preferably be used between the raw material layers as a glue. These can be synthetic resin tacking foils such as on phenol, melamine, or urea basis. Dry tacking foils are particularly easy to handle.

Preferably, the stack should be under a pressure of at least 1.5 N/mm². More preferred is a pressure of at least 2 N/mm². Such pressures have been successful in experiments.

It has been successful to apply the pressure to the stack at an increased temperature for at least 120 s.

In order to avoid the necessity of an exact cutting-to-form of the raw material layers and the dry tacking foils, if applicable, before gluing and coating, it is advantageous to cut the stack to form by the molding tool itself. Hereto, the molding tool can have a sharp edge cutting away unnecessary parts of the stack when closing the tool.

### SHORT DESCRIPTION OF THE DRAWINGS

Hereunder, the invention shall be explained in more details referring to exemplary embodiments. The individual features disclosed can also be relevant for the invention in other combinations.

FIG. 1 shows an injection molding tool for the invention as a molding tool for back molding having an upper mold and a lower mold, and a stack of raw material layers, for producing an inner covering part according to the invention.

FIG. 2 shows the injection molding tool of FIG. 1 in its closed condition.

FIG. 3 shows an inner covering part being back molded as a product of a method according to the invention using the injection molding tool of FIGS. 1 and 2.

FIG. 4 corresponds to FIG. 2 but differs therefrom in that the injection molding tool, again for the invention, is adapted for front molding.

FIG. 5 shows an inner covering part being front molded as a product of a method according to the invention using the injection molding tool of FIG. 4.

FIG. 6 corresponds to FIGS. 2 and 4 but differs therefrom in that the injection molding tool is adapted for front molding and back molding.

FIG. 7 shows an inner covering part being front molded and back molded as a product of a method according to the invention using the injection molding tool of FIG. 6.

### PREFERRED EMBODIMENTS OF THE INVENTION

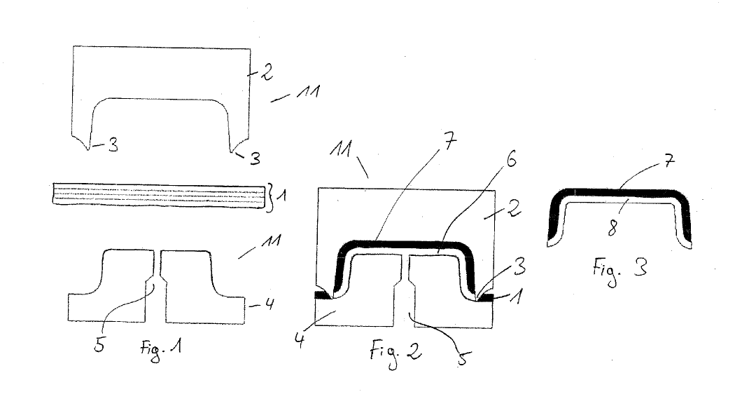

FIG. 1 shows in its middle a stack 1 of raw material layers loosely laid on top of each other. The uppermost layer is a wood face veneer and therebelow are three wood substrate veneers. A respective melamine synthetic resin tacking foil is positioned between the veneers.

An upper mold 2 of an injection molding tool 11 is shown above stack 1. The term “upper mold” shall only mean that it is positioned on that side of stack 1 which is facing the person looking on the completed inner covering part. Upper mold 2 has two sharp edges 3. A lower mold 4 is shown below. “Lower mold” 4 is a counterpart of “upper mold” 2 and is positioned on that side of stack 1 which is opposite to a person looking on the completed inner covering part.

Lower mold 4 has an injection mold nozzle 5 for introducing injection molding material. First, stack 1 is positioned between upper mold 2 and lower mold 4, and then upper mold 2 and lower mold 4 are moved into mutual contact. Therein, upper mold 2 presses stack 1 against lower mold 4, and edges 3 cut superfluous parts of stack 1 off (so-called pinching-off).

FIG. 2 shows injection molding tool 11 of FIG. 1 in its closed condition. Upper mold 2 now rests on lower mold 4 and edges 3 have cut off the respective superfluous parts of stack 1.

For injection molding, hot ABS of 260° C. is introduced through injection molding nozzle 5 at a pressure of 4.0 N/mm² into a cavity 6 on the lower mold side. Upper mold 2 and lower mold 4 have a temperature of 125° C., respectively. The pressure in cavity 6 is maintained for 240 s. Thereafter, loose stack 1 has been transformed into a compound 7 formed as desired and thoroughly glued. This compound 7 is shown in FIG. 2.

FIG. 3 shows the product of the method explained along FIG. 2. Compound 7 is back molded with an ABS layer 8.

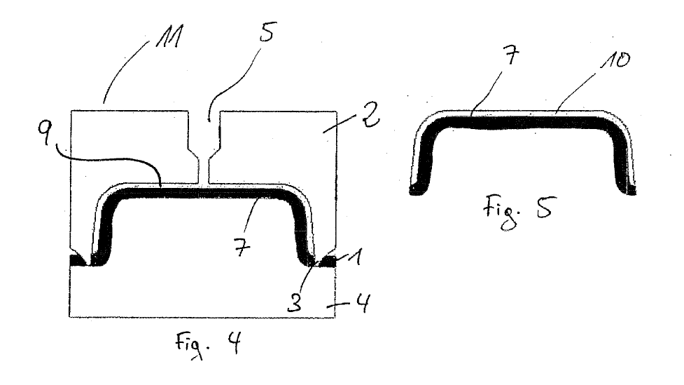

FIG. 4 is similar to FIG. 2, uses respective reference signs for corresponding features, and shows an injection molding tool 11 having an upper mold 2, a lower mold 4, an injection molding nozzle 5, and edges 3 at upper mold 2. In contrast to FIG. 2, injection molding nozzle 5 is positioned in upper mold 2, here, and a cavity 9 is formed for front molding on the upper mold side in this injection molding tool 11, correspondingly. In this injection molding tool, PMMA is introduced into cavity 9 through injection molding nozzle 5. Besides that, the explanations to FIG. 2 apply.

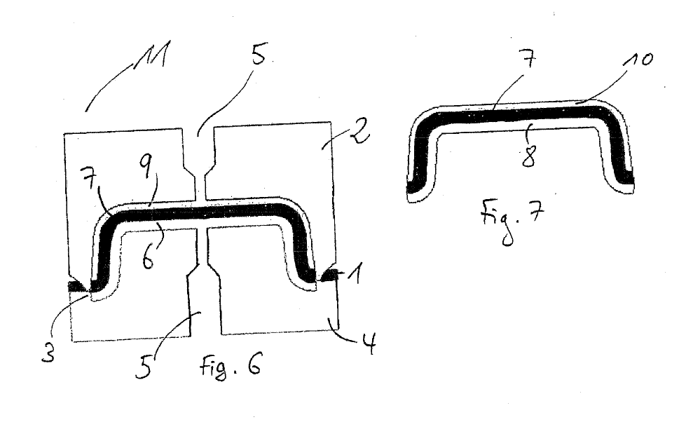

FIG. 5 shows a compound 7 front molded with a PMMA layer 10.

FIG. 6 shows an injection molding tool 11 adapted for front molding and back molding. Reference signs referring to features corresponding to FIGS. 2 and 4 are used again. Here again, an injection molding tool having an upper mold 2 and a lower mold 4 is shown. Both upper mold 2 and lower mold 4 have a respective injection molding nozzle 5. Injection molding nozzle 5 of upper mold 2 enters into a cavity 9 and injection molding nozzle 5 of lower mold 4 enters into a cavity 6. A compound 7 as described above is shown between cavities 6 and 9. As regards front molding, the explanations to FIG. 4 apply, and as regards back molding, the explanations to FIG. 2 apply.

The illustration of this injection molding tool 11 is strongly simplified. The two cavities 6 and 9 are formed subsequently. For example, one of the molds can be exchanged for a two-sided coating (compare also DE 43 01 444 C2).

FIG. 7 shows an inner covering part produced by means of the injection molding tool of FIG. 6 in which compound 7 is front molded with PMMA 10 and back molded with ABS 8.

1. A method for producing an inner covering part for motor vehicles, the method comprising the steps:
collecting raw material layers,
inserting said raw material layers together with a glue between said raw material layers into a molding tool (11) such that said raw material layers make up a stack (1) in said molding tool (11) and at least a part of the surface of said stack (1) is adjacent to a cavity (6, 9) of the closed molding tool (11),
introducing a molding material into the cavity (6, 9),
and gluing said raw material layers of said stack (1), being separated before said introduction of said molding material, in said molding tool (11) under at least one of heat supply and pressure,
characterized in that the temperature of said molding tool is between 90° C. and 140° C.

2. The method of claim 1 wherein said gluing is performed under both pressure and heat supply.

3. The method of claim 1 wherein said stack (1) is also changed in form.

4. The method of claim 1 wherein one of said raw material layers is a wood veneer.

5. The method of claim 1 wherein said glue is a dry tacking foil.

6. The method of claim 1 wherein a pressure of at least 1.5 N/mm² is applied onto said stack (1).

7. The method of claim 1 wherein the temperature of said molding material introduced is between 130° C. and 390° C.

8. The method of claim 1 wherein heat is supplied to said stack (1) for at least 120 s and simultaneously pressure is applied thereon for at least 120 s.

9. A method for producing an inner covering part for motor vehicles, the method comprising the steps:
collecting raw material layers,
inserting said raw material layers together with a glue between said raw material layers into a molding tool (11) such that said raw material layers make up a stack (1) in said molding tool (11) and at least a part of the surface of said stack (1) is adjacent to a cavity (6, 9) of the closed molding tool (11),
introducing a molding material into the cavity (6, 9),
and gluing said raw material layers of said stack (1), being separated before said introduction of said molding material, in said molding tool (11) under at least one of heat supply and pressure,
wherein the temperature of said molding tool is between 90° C. and 140° C.

10. A method for producing an inner covering part for motor vehicles, the method comprising the steps:
collecting raw material layers,
inserting said raw material layers together with a glue between said raw material layers into a molding tool (11) such that said raw material layers make up a stack (1) in said molding tool (11) and at least a part of the surface of said stack (1) is adjacent to a cavity (6, 9) of the closed molding tool (11),
introducing a molding material into the cavity (6, 9),
and gluing said raw material layers of said stack (1), being separated before said introduction of said molding material, in said molding tool (11) under at least one of heat supply and pressure,
wherein heat is supplied to said stack (1) for at least 120 s and simultaneously pressure is applied thereon for at least 120 s.

11. A method for producing an inner covering part for motor vehicles, the method comprising the steps:
collecting raw material layers,
inserting said raw material layers together with a glue between said raw material layers into a molding tool (11) such that said raw material layers make up a stack (1) in said molding tool (11) and at least a part of the surface of said stack (1) is adjacent to a cavity (6, 9) of the closed molding tool (11),
introducing a molding material into the cavity (6, 9),
and gluing said raw material layers of said stack (1), being separated before said introduction of said molding material, in said molding tool (11) under at least one of heat supply and pressure,
wherein said stack (1) is coated by a molding material on a front side of said stack and coated by a molding material on a back side of said stack.
